(19) United States
(12) Patent Application Publication
(10) Pub. No.: US 2008/0215754 A1
(43) Pub. Date: Sep. 4, 2008

(54) Bridging Data Network Communications

(76) Inventors: Petros Belimpasakis, Tampere (FI); Ilkka Koskinen, Tampere (FI); Peter Ujfalusi, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/667,497

(22) PCT Filed: Nov. 9, 2004
(86) PCT No.: PCT/FI04/00657

§ 371 Date: Oct. 29, 2007

(51) Int. Cl. G06F 15/16

(52) U.S. Cl. 709/245

(57) ABSTRACT

When a packet is sent from a node connected to the network requiring acknowledgements to a node behind the bridge, the original destination address (address of node behind the bridge) is changed. On the driver level, the destination address is replaced with the MAC address of the bridge, and the original destination address is moved to an additional field of the packet. Thus the communication between the sending node and the bridge appears to be point-to-point (from node to bridge). Accordingly, when the bridge receives the packet it is automatically acknowledged from the firmware, and the sending node does not try to resend it. The packet is forwarded to the driver of the bridge. The driver modifies again the received packet by replacing the destination address with the original one found in the “ORIGINAL TO”, additional field and at the same time completely removing that field. Thus the package looks substantially the same as the one originally generated by the application on the sending node.

### TECHNICAL FIELD OF THE INVENTION

The invention concerns an apparatus for bridging data communications between network nodes according to the preamble of claim 1. Furthermore, the invention concerns a network node for data communications to another network node via a bridge according to the preamble of claim 16. Yet furthermore the invention concerns a system for bridging data communications between multiple network platforms according to the preamble of claim 17. Yet furthermore the invention concerns a sub-assembly for bridging data communications according to the preamble of claim 18. Yet furthermore, the invention concerns the use of such apparatuses.

### BACKGROUND ART

A bridge relays traffic between multiple network interfaces. For example, a bridge connects two or more physical Ethernets together to form one bigger (logical) Ethernet.

Bridging is very flexible; the LAN's (Local Area Network's) can be either traditional Ethernet devices. Also the LAN can be constructed from pseudo-devices such as PPP (Point-to-Point Protocol), VPN's (Virtual Private Network) or WLAN's (Wireless Local Area Network). Typically all devices have same maximum packet size (MTU). The bridge does not necessarily fragment packets. Devices can support Ethernet or the like, for example have 6 byte source and destination address. The devices can also support promiscuous operation. The bridge can furthermore be able to receive all network traffic, not just traffic destined for its own address. Also the devices may allow source address spoofing. The bridge can send data over network as if it came from another host.

However in some networks such as wireless ones there are some additional features, like packet acknowledgement, that cause problems for the bridging.

For example, in WLAN, when a wireless node sends a packet to another one, it expects to receive an acknowledgement of reception. If the wireless node does not receive the acknowledgement, the wireless node tries to resend the packet. This acknowledgement has as destination the address of the sender of the original package. The acknowledgement has as origin the address of the host that the original data package was sent to as shown in the FIG. 1. In FIG. 1 terminal A and terminal C are coupled with a wireless network requiring acknowledgements (101) such as WLAN. Terminal A sends a packet to terminal C. The packet has the following data information: Source: A, Destination: C, and Data as content. Terminal C receives the packet. Terminal C sends acknowledgement to terminal A for receiving the packet. On the other hand the acknowledgement has the following data information: Source: C, Destination: A and Acknowledgement data as content.

However when bridging a network requiring acknowledgements such as a WLAN network with another network such as a fixed Ethernet network as shown in FIG. 2, acknowledgements will not work properly. If terminal C, which is connected to the bridge (B) over the wireless network requiring acknowledgements (101), sends a packet to terminal A, which is connected to the bridge (B) over any kind of network (100) such as Ethernet, the packet is forwarded through the bridge (B) to the destination device, which in FIG. 2 is terminal A. Terminal C expects to receive an acknowledgement from terminal A. However, since terminal A is a device operating typically without acknowledgement, there is simply no acknowledgement. Thus terminal A can be a fixed Ethernet device operating without acknowledgement. Therefore terminal C assumes that the package has not arrived and tries to resend it.

For example, a laboratory test for the above problem, made terminal C (e.g. a Windows XP PC with the Nokia D211 WLAN card) send the package 7 times, to the bridge (e.g. a Linux PC with tnetw1100b WLAN chipset, running in promiscuous mode). Thus the problem caused 6 times more traffic on the WLAN network.

A known solution for the problem is a bridge making the acknowledgement on behalf of the device behind the bridge. However, the acknowledgement packets are sent from a very low level of the stack, for example from the firmware. It is very commonly known that there is basically no easy way to have an access to modify the firmware. Moreover a specially designed firmware is needed in a WLAN card that acts as a bridge.

Another known alternative solution has been a proxy ARP (Address Resolution Protocol) technique, in which one host, usually a router, answers ARP requests intended for another machine. By “faking” its identity, the router accepts responsibility for routing packets to the “real” destination. The proxy ARP allows a site to use a single IP address with two physical networks.

Proxy ARP may also be used if the WLAN card of the bridge does not support promiscuous mode. Windows XP automatically uses Proxy ARP if the hardware does not support it. In addition, there are more disadvantages. For example, Proxy ARP is actually not a bridge according to the 802.11d standard. For another example Proxy ARP has to have IP awareness. Proxy ARP works only with IP protocol since it relays on ARP. For the Proxy ARP there should be different version for IPv4 and for IPv6, since ARP is different. Furthermore currently there is no IPv6 Proxy ARP support in Linux, due to technical implementation problems.

Yet another alternative solution has been simply to drop duplicate packages. This means that when duplicate packages are received from the bridge they should be dropped and not passed to the higher stack levels. However, the duplicate WLAN traffic is still going to be transmitted, for example on the air, wasting bandwidth and power of the network.

### SUMMARY OF THE INVENTION

It is therefore the object of the invention to save the bandwidth in the data communication bridging by reducing unnecessary resending and acknowledgement. The object is achieved by an apparatus for bridging data communications between at least two network nodes according to claim 1. In accordance with a further aspect of the invention the object is also achieved by a network node according to claim 16. In accordance with yet further aspect of the invention the object is also achieved by a system for bridging data communications between multiple network platforms in accordance with claim 17. Yet furthermore the object is achieved by a sub-assembly according to claim 18. Yet furthermore, the object is achieved by the use of such apparatuses.

In the apparatus for bridging data communications between at least two network nodes, a packet of the data communications has an original address for addressing the packet between the nodes. The original address is adapted to be replaced with an address of the bridging apparatus. Furthermore the original address is still retrievable in the actual packet. Thereby, the modified packet can fool the acknowledgement system between one of the nodes and the bridge. The data communication between the bridging apparatus and one of the nodes looks like a point-to-point communication fooling the acknowledgement system therebetween. Unnecessary packet duplications on the network requiring the acknowledgement can be avoided. Thereby the bandwidth and power can be saved. Furthermore no specific firmware or hardware modification of the interface of the bridging apparatus is needed because the packet is being modified. The bridge can be trans-parent to any protocol (not only IP). Furthermore IP stack is not necessarily needed on bridge, which makes various embodiments independent on a network protocol. In a further embodiment 802.1d standard based bridging can be used in the bridge.

In various further embodiments of the invention an original destination address, i.e. address of node behind the bridge, is changed, when a packet is send from a node, which is connected to the network requiring acknowledgements, to a node behind the bridge. On the NIC (Network Interface Card) driver level, the destination address is replaced with the MAC (Media Access Control) address of the bridge, and the original destination address is moved to an additional field (e.g. named “Original to”) of the packet. Thus the communication between the sending node and the bridge seems to be point-to-point data communications (from node to bridge). Therefore when the bridge receives the packet, the packet is automatically acknowledged from the firmware, and the sending node does not try to resend it.

Still referring to the various further embodiments, the package can be forwarded to the driver of the NIC of the bridge. The specially modified driver modifies again the received package. This is done by replacing the destination address with the original one found in the “Original to” additional field of the packet. Furthermore the additional field can be removed later or at the same time when replacing the address. Therefore the package may look like substantially the same as the one originally generated by the application on the sending node. Furthermore the packet is passed to the bridging software for forwarding to the other network.

In various further embodiments modifications are only the drivers (or alternatively referred to as pseudo-drivers) of the NIC of the network, which requires acknowledgement, are modified.

Yet further embodiments of the invention have been specified in the dependent claims.

### BRIEF DESCRIPTION OF THE DRAWINGS

The invention will now be described, by way of examples only, with reference to the accompanying drawings, in which:

FIG. 1 depicts an example of a packet and acknowledgement transmission in a wireless network,

FIG. 2 depicts an example of a network bridging,

FIG. 3 depicts stack layers and packet conversion in drivers in accordance with further embodiments of the invention,

FIG. 4 depicts a packet exchange and conversion sequence in accordance with further embodiments of the invention.

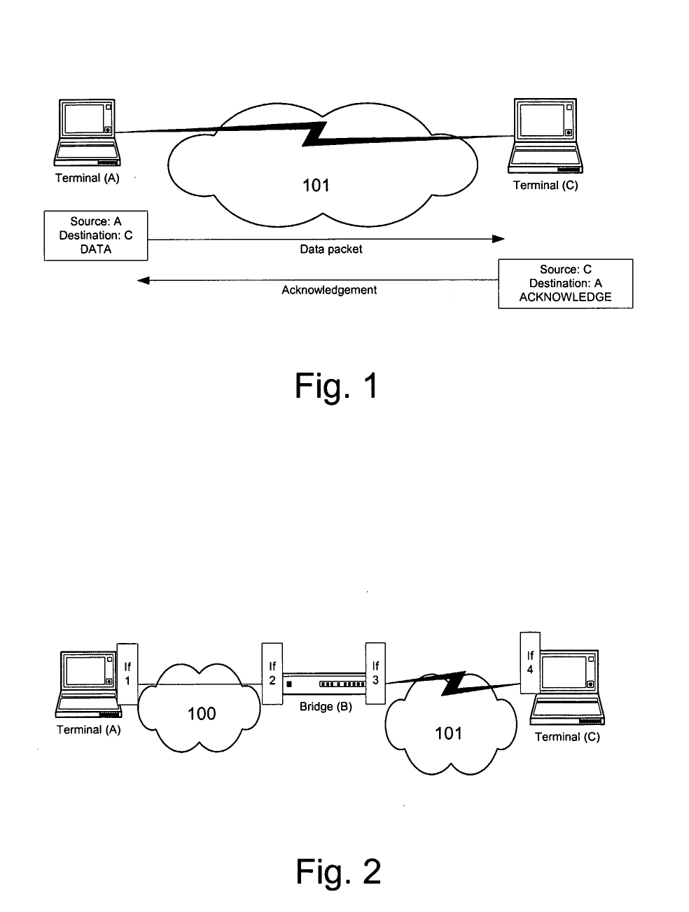

### DESCRIPTION OF FURTHER EMBODIMENTS

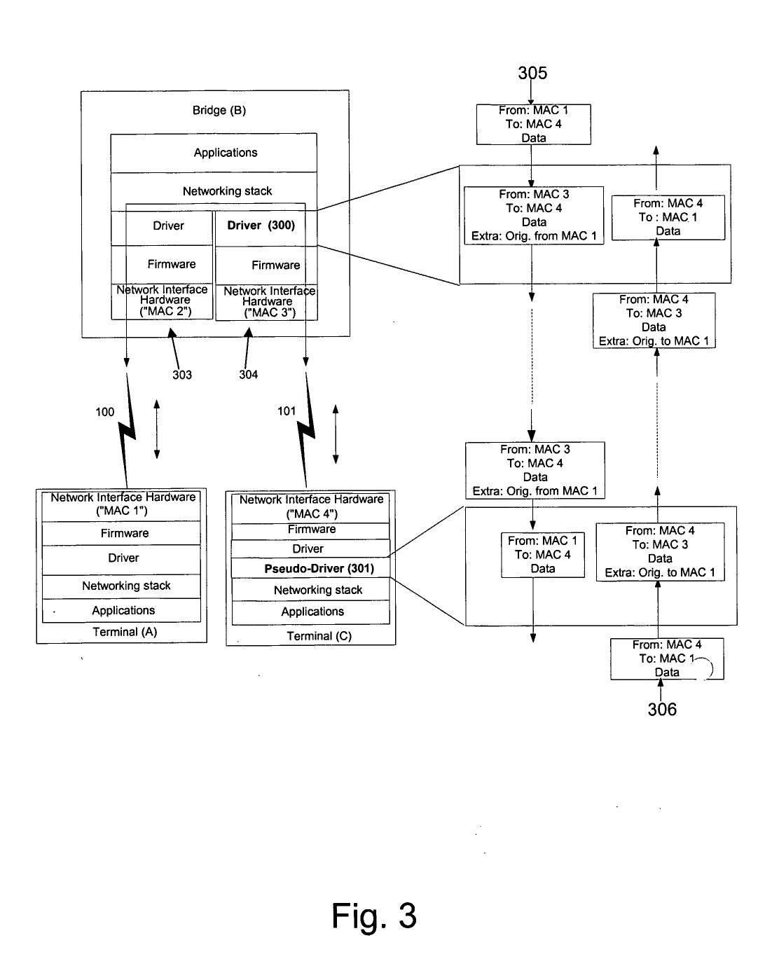

FIG. 3 presents different stacks in the related devices of the system for bridging data communications between two networks in accordance with further embodiments of the invention. Two networks are illustrated for the sake of clarity. It should be noted that the invention is not limited to the two different data communications network but can operate in multiple network platforms. FIG. 3 depicts also the packet conversions applied in the pseudo-drivers of the devices. In FIG. 3 two network nodes terminal A and terminal B are adapted to communicate via bridge B. Terminal A is coupled with the bridge B via the data communication network (100) not necessarily requiring acknowledgement, for example Ethernet or the like. Terminal C is coupled with the bridge B via the data communication network requiring acknowledgement (101), for example WLAN or the like. Terminal A comprises various stacks for data communication. The lower level stack can be Network Interface Hardware having an address MAC 1. Next there is firmware, driver, some networking stack, and the uppermost can be the applications. The bridge B comprises two coupling interfaces: coupling interface 303 for coupling with the terminal A and coupling interface 304 for coupling with the terminal B. The coupling interface 303 comprises lower level stacks such as Network Interface Hardware having the address MAC 2. The coupling interface 303 has also firmware and driver stacks. The coupling interface 304 has also lower level stacks such as Network Interface Hardware having the address MAC 3. Furthermore the coupling interface 304 has firmware and the driver 300. The driver 300 is configured to modify the packet data communication, which is bridged between the terminals A and C as for example further described below. Terminal C comprises various stacks for data communication. The lower level stack can be Network Interface Hardware having an address MAC 4. Next there is firmware, some networking stack, and the uppermost can be the applications. The terminal C comprises also the pseudo-driver 301. The pseudo driver 301 is configured to modify the packet data communication as for example described further.

Referring to a packet transmission 305 in the FIG. 3, terminal A sends the packet intended to the terminal C. The packet comes from MAC 1 (i.e. terminal A) and it's intended to MAC 4 (i.e. terminal C). The packet is relayed by the bridge B bridging the data communications between the terminals A and C. The driver 300 of the bridge B is configured to replace the address MAC 1 with an address MAC 3, which is the address of the bridge B. Furthermore the driver 300 is configured to add an additional field to the packet. The additional field has information that the packet is from MAC 1, i.e. that the original address of packet is MAC 1. The packet is forwarded to terminal C from the bridge B. The terminal C receives the packet and the pseudo-driver 301 modifies the packet so that it has substantially the original format. The pseudo-driver 301 replaces the MAC 1 address with the original MAC 1 address. The pseudo-driver 301 receives the information from the additional field of the packet. Furthermore the pseudo-driver 301 can remove the additional field of the packet.

Moreover referring to a packet transmission 306 in the FIG. 3, terminal C sends the packet intended to the terminal A. This can be the follow-up situation after the reception of the packet from terminal A. However it should be noted that this can also be independent from the reception of the packet from the terminal A. Terminal C sends the packet intended to the terminal A. The packet is from MAC 4 (i.e. terminal C) and it's intended to MAC 1 (i.e. terminal A). The pseudo-driver 301 is configured to replace the destination address MAC 1 with an address MAC 3, which is the address of the bridge B. Furthermore the pseudo-driver 300 is configured to add an additional field to the packet. The additional field has information that the packet is to MAC 1, i.e. that the original destination address of packet is MAC 1. The packet is forwarded to the bridge B. The bridge B receives the packet and the driver 300 modifies the packet so that it has substantially the original format. The driver 300 replaces the MAC 3 address with the original MAC 1 address. The pseudo-driver 301 receives the information from the additional field of the packet. Furthermore the driver 300 can remove the additional field of the packet.

### Various Further Implementations

Various further embodiments of the invention may relief the duplication problem without any substantial changes in the firmware of the hardware. Modifications may only be applied on the drivers (or alternatively referred to as pseudo-drivers) of the Network Interface Cards (NICs) of the network that requires the acknowledgements.

Some further embodiment can be applied in a Bluetooth—WLAN Gateway device. For example, the embodiments may relief the packet duplication and bandwidth waste problems in such a system. Thus a further preferable embodiment in the Bluetooth—WLAN Gateway device can be applied for avoiding duplication of packets in the WLAN interface.

The WLAN driver on the Bluetooth—WLAN Bridge can be modified in order to relief the packet duplication. Thus the implementation can be merely software or logic based and does not necessarily require any substantial hardware modification in the bridging device.

### Various Further Processes

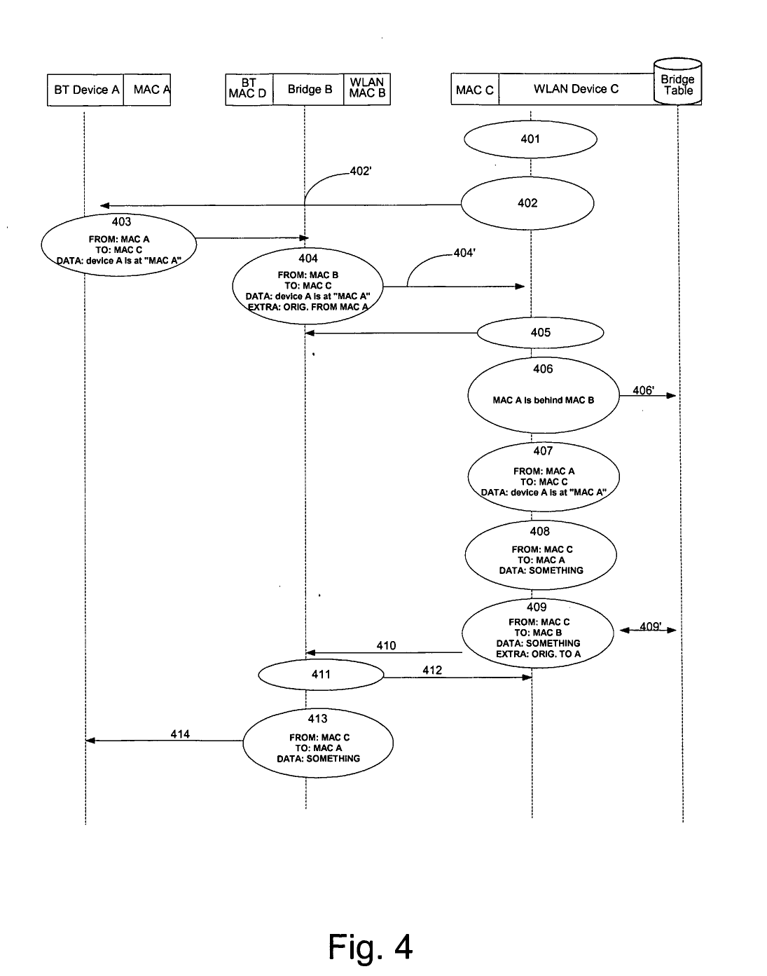

FIG. 4 shows an example of data and acknowledgment flow between the two communicating nodes (alternatively referred to as communicating peers) and a bridge. As shown in the FIG. 4, there is being shown a terminal A. For example, the terminal A can be a Bluetooth Device with PAN (Personal Area Network) interface. The terminal has an address MAC A. For example, the PAN interface can have the Bluetooth address MAC A. Terminal C is also shown in FIG. 4. Terminal C has an address MAC C. The terminal C can, for example, be a WLAN device C with MAC address C. The system of FIG. 4 includes also the bridging apparatus B. The bridging apparatus B has an address MAC D on the interface to the terminal A and an address MAC B on the interface to the terminal C. The bridge B can be a Bluetooth-WLAN Bridge, which has Bluetooth address MAC D on the Bluetooth interface and the address MAC B on the WLAN interface. The bridging between the two interfaces may be done with the 802.1d standard.

In a further embodiment, the Bluetooth devices are connected using the Bluetooth PAN profile, and the WLAN devices could be connected either via ad-hoc or infrastructure mode.

Referring back to FIG. 4, the system of FIG. 4 is operable with many clients, for example in the Bluetooth and WLAN networks, but for simplicity an example with only a Bluetooth/a WLAN device is described.

The step-by-step message exchange, as shown in the diagram of FIG. 4, can be the following. In the step 401 the WLAN device C wants to send a message “SOMETHING” to a Bluetooth device A. In the step 402 an ARP request is broadcasted on the WLAN network, asking the MAC address of the device A. In the step 402′ the bridge B receives the broadcast message and forwards it to the Bluetooth interface MAC A. In the step 403 the Bluetooth device A receives the request and replies. The reply contains the following information: Source address of sender (MAC A), Destination address (MAC C), the data, which is (Device A is at “MAC A”). In the step 404 the bridge B receives, from the Bluetooth interface MAC A, the reply and forwards it to the WLAN driver of the bridge B. The WLAN driver modifies substantially all the outgoing packets. The WLAN driver is adapted to replace the original source address (“MAC A”) with its own address (“MAC B”). Therefore it seems that the bridge B is the sender. Furthermore, the WLAN driver is adapted to keep the original source address in an additional field in the packet, for further usage. Such field can be provided, for example, in an Ethernet packet. Thus the WLAN driver can modify the packet and record the original address information to the packet. In the step 404′ the modified packet is forwarded to the WLAN interface. The packet can, for example be sent over the air.

The WLAN device C receives the package. In the step 405 the firmware of the WLAN interface automatically acknowledges the reception back to the sender (“MAC B”), with the WLAN specific acknowledgement. The packet is forwarded to the WLAN driver of the device C. In the step 406 the WLAN driver extracts the packet information. The information that MAC A is actually behind MAC B is extracted. The driver finds out that this a specially modified packet (from the extra field) and now it knows that address “MAC A” is behind the bridge with address “MAC B”. This information is stored in a local temporary bridge table in the step 406′. In the step 407 the driver modifies the packet. The driver gets the original source address form the extra field and puts it back into the packet's source address. Thus the WLAN driver changes the response. The packet contains now the following information “From: MAC A, To: MAC C, Data: device A is at “MAC A”. The packet (i.e. the ARP reply) is now forwarded to the networking stack for sending. In the step 408 the networking stack of the terminal C sends the actual data. The packet contains the following information: Source address (“MAC C”), destination address (“MAC A”) and the actual data (“SOMETHING”). In the step 409 when the WLAN driver receives the packet, the driver modifies the packet. The WLAN driver resolves the bridge (“MAC B”), behind which the Device A (“MAC A”) is, from the local temporary bridge table in the step 409′. Thus, the destination address is changed to “MAC B” and the original destination (“MAC A”) is stored in the extra field of the WLAN packet. The packet contains the following data: From: MAC C, To MAC: B, Data: SOMETHING, Extra: Orig. To A. In the step 410 the packet is send to the WLAN interface and goes on the air. In the step 411 the bridge B receives the packet on the WLAN interface. In the step 412 the firmware of the WLAN interface automatically acknowledges the reception back to the sender (“MAC C”), with the WLAN specific acknowledgement. The driver of the bridge B discovers that the received packet is a specially modified packet. This is due to the information on the extra field. Therefore the driver of the bridge B modifies the packet back to the original format in the step 413. The destination is replaced and it is now an address “MAC A”. The packet is forwarded to the networking stack and the bridging software. The packet is transferred to the Bluetooth interface and further the packet is send over the air in the step 414. The Bluetooth device A receives the packet as it was originally generated by the networking stack of the device C.

It should be noted that the scenario of FIG. 4 is similar when device A sends data to device C.

### RAMIFICATIONS AND SCOPE

Although the description above contains many specifics, these are merely provided to illustrate the invention and should not be construed as limitations of the invention's scope. It should be also noted that the many specifics can be combined in various ways in a single or multiple embodiments. Thus it will be apparent to those skilled in the art that various modifications and variations can be made in the apparatuses and processes of the pre-sent invention without departing from the spirit or scope of the invention.

1. A bridging apparatus for bridging data communications between at least two network nodes, the data communications comprising at least one packet having an original destination address for addressing the packet between the at least two nodes, wherein said apparatus is configured to replace said original destination address with an address of said bridging apparatus so that the original destination address is retrievable in the packet.

2. A bridging apparatus according to claim 1, wherein the apparatus is configured to save the original destination address in an additional field in the packet.

3. A bridging apparatus according to claim 1, wherein the apparatus is configured to generate an additional field in the packet so that the original destination address is storageable in the additional field.

4. A bridging apparatus according to claim 1, wherein said apparatus and one of the nodes is adapted to read the address of the bridging apparatus so that the data communication between the at least two nodes is adapted to resemble point-to-point data communications between said apparatus and said one of the nodes.

5. A bridging apparatus according to claim 1, wherein the apparatus is configured to acknowledge the received packet.

6. A bridging apparatus according to claim 2, wherein said apparatus is configured to replace the address of the bridging apparatus with the original destination address.

7. A bridging apparatus according to claim 6, wherein said apparatus is adapted to obtain the original destination address from said additional field of the packet.

8. A bridging apparatus according to claim 6, wherein said apparatus is configured to remove said additional field in the packet.

9. A bridging apparatus according to claim 1, wherein the address comprises a medium access control address.

10. A bridging apparatus according to claim 1, wherein the apparatus comprises a bridge configured to operate between a network requiring acknowledgement and a network not requiring acknowledgement.

11. A bridging apparatus according to claim 1, wherein the apparatus comprises a bridge between Bluetooth and WLAN networks.

12. A bridging apparatus according to claim 1, wherein the apparatus further comprises at least two interfaces, each interface being adapted to communicate with corresponding network node of the nodes.

13. A bridging apparatus according to claim 12, wherein the each interface has an address.

14. A bridging apparatus for bridging data communications between at least two network nodes, the data communications comprising at least one packet having an address of the bridging apparatus for addressing the packet between the at least two nodes, wherein said bridging apparatus is configured to replace said address of the bridging apparatus with an original destination address read by said bridging apparatus directly from said packet.

15. A system for bridging data communications between multiple network platforms the data communications comprising at least one packet having an address for addressing the packet between the platforms, wherein said system
is configured to replace said address with an address of a bridging apparatus so that the original destination address is retrievable in the packet, and
is configured to replace the address of the bridging apparatus with the original destination address read by said bridging apparatus directly from said packet.

16. A bridging sub-assembly for bridging data communications between at least two network nodes, the data communications comprising at least one packet having an original destination address for addressing the packet between the at least two nodes, wherein said sub-assembly further comprises a driver arranged to replace said original destination address with an address of said bridging sub-assembly so that the original destination address is retrievable in the packet.

17. A bridging sub-assembly for bridging data communications between at least two network nodes, the data communications comprising at least one packet having an address of the bridging sub-assembly for addressing the packet between the at least two nodes, wherein said sub-assembly further comprises a driver arranged to replace said address of the bridging sub-assembly with an original destination address read by said driver directly from said packet.

18. A method for bridging data communications between at least two network nodes, the data communications comprising at least one packet having an original destination address for addressing the packet between the at least two nodes, wherein said method comprises replacing the original destination address with an address of a bridging apparatus so that the original destination address is retrievable in the packet.

19. A method for bridging data communications between at least two network nodes, the data communications comprising at least one packet having an address of a bridging apparatus for addressing the packet between the at least two nodes, wherein said method comprises replacing said address of the bridging apparatus with an original destination address read by said bridging apparatus directly from said packet.

20. A computer readable medium having a computer program stored thereon comprising computer program code adapted to perform the method of claim 18 when said program is run on a computer.

21. A computer program comprising computer program stored thereon comprising computer program code adapted to perform the method of claim 19 when said program is run on a computer.

22. (canceled)

23. (canceled)
